(19) United States
(12) Patent Application Publication
(10) Pub. No.: US 2022/0364957 A1
(43) Pub. Date: Nov. 17, 2022

(54) SYSTEM AND METHOD FOR CLOUD-BASED FAULT CODE DIAGNOSTICS

(71) Applicant: Haier US Appliance Solutions, Inc., Wilmington, DE (US)

(72) Inventors: Yuen-Pik Ho, Louisville, KY (US); Wei Zhou, Louisville, KY (US)

(21) Appl. No.: 17/320,359

(22) Filed: May 14, 2021

(51) Int. Cl. G01M 99/00

(52) U.S. Cl. CPC G01M 99/005; G06N 20/00

(57) ABSTRACT

A cloud diagnostic system and a method of operating the same to diagnose or predict potential fault conditions in an appliance includes connecting the appliance to a cloud diagnostics server directly over a network or through a service computer, receiving, at the cloud diagnostics server, appliance data from the appliance, analyzing the appliance data using one or more machine learning models on the cloud diagnostics server to diagnose or predict the potential fault conditions along with a confidence score, adjusting the confidence score based on historical fault data from a historical guidance service, and communicating the potential fault conditions to the appliance, to a user of the appliance, or to a field technician.

### FIELD OF THE INVENTION

The present subject matter relates generally to consumer or commercial appliances, such as domestic appliances, and more particularly to methods of using cloud-based diagnostics procedures to identify faults in such appliances.

### BACKGROUND OF THE INVENTION

Generally, modern domestic appliances (e.g., refrigerator appliances, oven appliances, dishwasher appliances, washing machine appliances, dryer appliances, microwave appliances, air conditioning appliances, etc.) are made up of multiple components, parts, assemblies, sub-assemblies, etc. Final appliance assembly is typically performed in a single factory assembly line, but each component or sub-assembly may be produced at another location, on a different date, and even by a third-party manufacturer. Regardless the processes and safeguards in place, it is possible that the quality of appliances made on a production line may be negatively impacted by a variety or anomalies or factors associated with its various components. For example, quality may be impacted by the skill or proficiency of assembly line workers, the quality of components supplied, quality assurance errors, etc. Moreover, these factors may affect more than one appliance and resulting appliance maintenance issues may be repeatable among effected appliances.

Notably, failure of any specific appliance component may result in appliance faults and operating errors. For example, although each component is often related to a specific sub-assembly and intended to perform different functions for the appliance, they may influence or affect performance of other assemblies or overall performance of the appliance in ways that are difficult to predict or identify. Tracing those errors back to the root cause is very difficult given the multitude of parts, suppliers, assemblers, suppliers, and other parties involved.

However, when issues with a particular appliance arise, the consumer typically schedules a maintenance visit and the service or maintenance technician must diagnose the issue without any foresight into such repeatable maintenance issues. This diagnostic procedure may often result in a time-consuming, costly, and even inaccurate problem diagnosis. For example, existing methods for monitoring performance or diagnosing problems of an appliance are typically limited to recording and evaluating signals from individual components or assemblies. For instance, operation and sensory data for each component may be independently recorded and evaluated for each cycle. This data is typically unstructured and must be evaluated in isolation. Thus, it is difficult (e.g., time consuming, processing intensive, inefficient, or inaccurate) to discern how one component or assembly might affect another.

Accordingly, improved systems and methods for diagnosing fault conditions in appliances are desired. In particular, systems and methods that utilize fault data collected from various sources for improved accuracy and efficiency of a diagnostic procedure would be advantageous.

### BRIEF DESCRIPTION OF THE INVENTION

Aspects and advantages of the invention will be set forth in part in the following description, or may be obvious from the description, or may be learned through practice of the invention.

In one exemplary embodiment, a method of diagnosing or predicting potential fault conditions in an appliance if provided. The method includes connecting the appliance to a cloud diagnostics server over a network such that data from the appliance is transmittable to the cloud diagnostics server, receiving, at the cloud diagnostics server, appliance data from the appliance, analyzing the appliance data using a machine learning model on the cloud diagnostics server to diagnose or predict the potential fault conditions, and communicate the potential fault conditions to the appliance, to a user of the appliance, or to a field technician.

In another exemplary embodiment, a cloud diagnostics system for diagnosing or predicting potential fault conditions in an appliance is provided. The cloud diagnostics system includes a cloud diagnostics server in operative communication with the appliance over a network for receiving appliance data from the appliance, the cloud diagnostics server being configured to analyze the appliance data using a machine learning model to diagnose or predict the potential fault conditions along with a confidence score and a historical guidance service that collects historical fault data from a plurality of appliances, sorts the historical fault data, and analyzes the historical fault data, wherein the confidence score is adjusted based at least in part on the historical fault data.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a cloud diagnostics system for diagnosing or predicting potential fault conditions in a refrigerator appliance according to exemplary embodiments of the present disclosure.

FIG. 2 provides a method for diagnosing issues with an exemplary appliance using a cloud diagnostics system according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

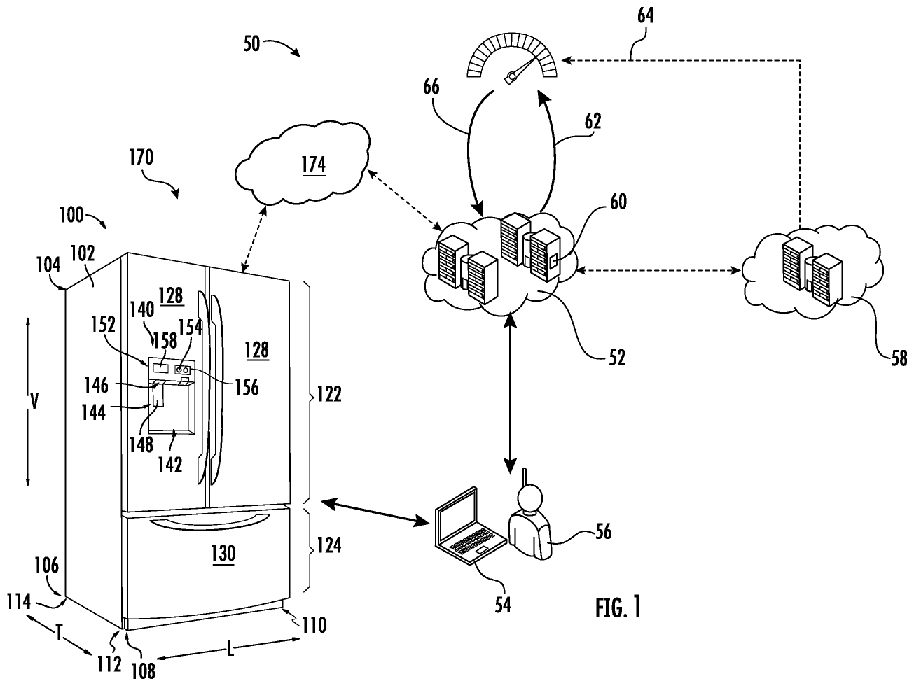

Referring now to the figures, an exemplary cloud diagnostics system 50 will be described in accordance with exemplary aspects of the present subject matter. Specifically, FIG. 1 provides a schematic view of cloud diagnostics system 50 interacting with a single consumer appliance (e.g., illustrated herein as refrigerator appliance 100). Although cloud diagnostics system 50 is illustrated herein as interacting with refrigerator appliance 100, it should be appreciated that this schematic representation is only intended to facilitate discussion of aspects of the present subject matter. In this regard, for example, although the exemplary appliance is shown as a refrigerator appliance in FIG. 1, it is recognized that the benefits of the present disclosure apply to other types and styles of appliances. For instance, the present disclosure is understood to apply to oven appliances, dishwasher appliances, washing machine appliances, dryer appliances, microwave appliances, air conditioning appliances, etc. Consequently, the description set forth herein is for illustrative purposes only and is not intended to be limiting in any aspect to any particular appliance or configuration.

As will be described in more detail below, cloud diagnostics system 50 may include a cloud diagnostics server 52 that is connected to refrigerator appliance 100 or any other suitable appliance or appliances for performing fault diagnosis or otherwise improving the performance of one or more appliances. In addition, cloud diagnostics system 50 may include one or more service computers 54 that may be operated by, for example, a maintenance technician 56 for retrieving and transmitting appliance data. Furthermore, cloud diagnostics server 52 may include or may be in operative communication with a historical guidance service (e.g., identified herein generally by reference numeral 58) for communicating appliance data and/or historical data for similar appliances. Although cloud diagnostics server 52 and historical guidance service 58 are illustrated in FIG. 1 as being stored on separate servers that are in communication with each other, it should be appreciated that according to alternative embodiments other system configurations are possible. For example, cloud diagnostics server 52 and historical guidance service 58 may be embodied in or incorporated into a single remote server or even a single model on a server. Each of these parts of cloud diagnostics system 50 will be described below in more detail.

Referring still to FIG. 1, refrigerator appliance 100 will be described in accordance with exemplary embodiments of the present subject matter. For example, refrigerator appliance 100 includes a cabinet 102 that is generally configured for containing and/or supporting various components of refrigerator appliance 100 and which may also define one or more internal chambers or compartments of refrigerator appliance 100. In this regard, as used herein, the terms “cabinet,” “housing,” and the like are generally intended to refer to an outer frame or support structure for refrigerator appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of refrigerator appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, refrigerator appliance 100 generally defines a vertical direction V, a lateral direction L, and a transverse direction T, each of which is mutually perpendicular, such that an orthogonal coordinate system is generally defined. As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing appliance 102.

Housing 102 defines chilled chambers for receipt of food items for storage. In particular, housing 102 defines fresh food chamber 122 positioned at or adjacent top 104 of housing 102 and a freezer chamber 124 arranged at or adjacent bottom 106 of housing 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well. Consequently, the description set forth herein is for illustrative purposes only and is not intended to be limiting in any aspect to any particular appliance or configuration.

Refrigerator doors 128 are rotatably hinged to an edge of housing 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in the closed configuration in FIG. 1. One skilled in the art will appreciate that other chamber and door configurations are possible and within the scope of the present invention.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment (not shown) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring still to FIG. 1, a schematic diagram of an external communication system 170 will be described according to an exemplary embodiment of the present subject matter. In general, external communication system 170 is configured for permitting interaction, data transfer, and other communications between refrigerator appliance 100 and one or more external devices (e.g., such as portions of cloud diagnostics system 50). For example, this communication may be used to provide and receive operating parameters, user instructions or notifications, performance characteristics, user preferences, fault conditions or data, or any other suitable information for improved performance of refrigerator appliance 100. In addition, it should be appreciated that external communication system 170 may be used to transfer data or other information to improve performance of one or more external devices or appliances and/or improve user interaction with such devices.

For example, external communication system 170 permits controller 156 of refrigerator appliance 100 to communicate with a separate device external to refrigerator appliance 100, referred to generally herein as cloud diagnostics server 52. As described in more detail below, these communications may be facilitated using a wired or wireless connection, such as via a network 174. In general, cloud diagnostics server 52 may be any suitable device separate from refrigerator appliance 100 that is configured to provide and/or receive communications, information, data, or commands from a user. In this regard, cloud diagnostics server 52 may be, for example, a cloud-based server located at a distant location, such as in a separate state, country, etc. According to an exemplary embodiment, appliance 100 may communicate with cloud diagnostics server 52 over network 174, such as the Internet, to transmit/receive data or information, provide user inputs, receive user notifications or instructions, interact with or control refrigerator appliance 100, etc. According to exemplary embodiments, cloud diagnostics server 52 may be configured to receive appliance data and diagnose or predict potential fault conditions, as will be described in more detail below.

In general, communication between refrigerator appliance 100, cloud diagnostics server 52, and/or other user devices or appliances may be carried using any type of wired or wireless connection and using any suitable type of communication network, non-limiting examples of which are provided below. For example, cloud diagnostics server 52 may be in direct or indirect communication with refrigerator appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Now that the construction and configuration of cloud diagnostics system 50 and refrigerator appliance 100 have been presented according to an exemplary embodiment of the present subject matter, an exemplary method 200 for diagnosing or predicting potential fault conditions in an appliance is provided. Method 200 can be used to operate cloud diagnostics system 50 and refrigerator appliance 100, or to operate any other suitable appliance and diagnostic system. In this regard, for example, controller 156 and/or a controller remotely positioned within cloud diagnostics system 50 may be configured for implementing method 200. However, it should be appreciated that the exemplary method 200 is discussed herein only to describe exemplary aspects of the present subject matter and is not intended to be limiting.

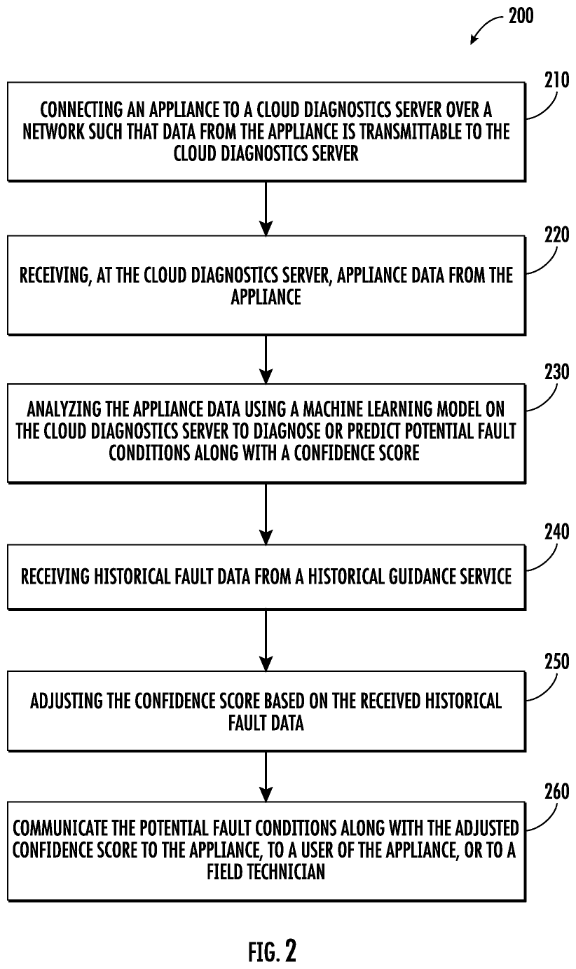

As shown in FIG. 2, method 200 includes, at step 210, connecting an appliance to a cloud diagnostics server over a network such that data from the appliance is transmittable to the cloud diagnostics server. For example, continuing the example from above, refrigerator appliance 100 may be connected to cloud diagnostics system 50, e.g., via cloud diagnostics server 52. It should be appreciated that refrigerator appliance 100 (or any other suitable appliances) may be connected to cloud diagnostics server in any manner suitable for facilitating data transmission therebetween.

For example, according to the illustrated embodiment, the step of connecting refrigerator appliance 100 to cloud diagnostics server 52 (as shown in solid lines) may include connecting a service computer 54 to refrigerator appliance 100 such that appliance data from refrigerator appliance 100 is transmittable to service computer 54. In this manner, service computer 54 may be plugged into controller 156, connected via a wireless network as described herein, other otherwise connected in any other suitable manner to download various appliance data, such as operational or performance data, fault codes or indications, or other event occurrence data. Service computer 54 may in turn upload this appliance data to cloud diagnostics server 52, e.g., through any suitable network (e.g., such as network 174). According to exemplary embodiments, service computers 54 may be connected to appliances such as refrigerator appliance 100 when a service or maintenance technician visits a residence where the appliance operates, e.g., on a service call to repair or diagnose issues with the appliance.

As explained above, service computers 54 are typically used to upload appliance data when the appliance being serviced or diagnosed is not a “smart” or “connected” appliance, e.g., such that it is not connected to a wireless network. However, it should be appreciated that connected appliances may also communicate with cloud diagnostics server 52 in a manner similar to those appliances connected through service computers 54. For example, such connected appliances may communicate instead directly through network 174 (e.g., as shown by dotted lines in FIG. 1). In this regard, a controller of the appliance, such as controller 156 of refrigerator appliance 100, may periodically transmit appliance data to cloud diagnostics server 52. In addition, or alternatively, controller 156 may transmit data at specified time intervals or when certain conditions occur that indicate service may be needed or a fault may be present. It should be appreciated that the communication of appliance data from refrigerator appliance 100 to cloud diagnostics server 52 may be achieved in any other suitable manner while remaining within the scope of the present subject matter.

Regardless whether appliances are connected to cloud diagnostics server 52 directly through network 174 or indirectly through service computers 54, these appliances may transmit useful appliance data that cloud diagnostics system 50 may use to diagnose issues, predict faults, or otherwise improve the performance of one or more appliances that are interacting with cloud diagnostics system 50. Thus, step 220 generally includes receiving, at the cloud diagnostics server, appliance data from the appliance. Specifically, continuing the example from above, appliance data transmitted from refrigerator appliance 100 may be received at cloud diagnostics server 52.

Notably, the appliance data transmitted from refrigerator appliance 100 to cloud diagnostics server 52 may be any data or information that may be suitable for assessing appliance performance or potential fault conditions. In this regard, for example, the appliance data may include at least one of appliance identification data, manufacturing information, and operational data related to potential fault conditions. According to exemplary embodiments, the manufacturing information may include at least one of a model number, a product line, the manufacturing date, the manufacturing location, a unique session identification, a batch number, etc. In addition, the manufacturing information may include important system information such as at least one of a list of appliance components or supplier identification for one or more appliance components. Furthermore, the transmitted appliance data may include event logs, operating history, internal diagnostic results, etc.

As described in more detail below, cloud diagnostics system 50 may use all this information to identify fault clusters, trends, or repeatable issues that arise with respect to one or more appliances, assemblies used in such appliances, components or subcomponents, or parts of such appliances. These issues or potential fault conditions may be traced to specific parts, appliance manufacturers, assembly dates, manufacturing dates, materials used, etc. Moreover, this information may be used to more accurately predict and identify potential issues with the performance of one or more appliances (e.g., other than refrigerator appliance 100) interacting with cloud diagnostics system 50.

Method 200 may further include, at step 230, analyzing the appliance data using a machine learning model on the cloud diagnostics server to diagnose or predict potential fault conditions. In general, the appliance data received at step 220 may be input into the machine learning model, which may be designed and configured to generate potential fault conditions for the purposes of fault diagnosis. Exemplary machine learning models will be described below according to exemplary embodiments. However, it should be appreciated that any suitable model may be used to analyze the data received at step 220, and the present subject matter is not intended to be limited to the specific models described herein unless indicated otherwise.

As explained briefly above, cloud diagnostic server 52 can be used to host a service platform, a cloud-based application, and/or an information database (e.g., a machine-learned model, a series of machine learning models, received data, or other relevant service data—optionally including intermediate processing data products). Cloud diagnostic server 52 and other portions of cloud diagnostic system 50 can be regulated or implemented using any suitable computing device(s). In this regard, each server generally includes a controller (e.g., similar to controller 156) having one or more processors and one or more memory devices (i.e., memory). The one or more processors can be any suitable processing device (e.g., a processor core, a microprocessor, a CPU, an ASIC, a FPGA, a microcontroller, etc.) and can be one processor or a plurality of processors that are operatively connected. The memory device can include one or more non-transitory computer-readable storage mediums, such as RAM, DRAM, ROM, EEPROM, EPROM, flash memory devices, magnetic disks, etc., or combinations thereof. The memory devices can store data and instructions (e.g., on-transitory programming instructions) that are executed by the processors to cause the remote server to perform operations. For example, instructions could be instructions for receiving/transmitting component signals (e.g., including data or information), appliance data or performance metrics, fault codes or conditions, analyzation results, machine-learned models, etc.

In some embodiments, cloud diagnostics server 52 can store or include one or more machine-learned models (e.g., as identified generally by reference numeral 60). As examples, the machine-learned model(s) 60 can be or can otherwise include various machine-learned models such as, for example, neural networks (e.g., deep neural networks, etc.), support vector machines, decision trees, ensemble models, k-nearest neighbors models, Bayesian networks, logistics models, gradiant boost models, XGBoost models, or other types of models including linear models or non-linear models. Example neural networks include feed-forward neural networks (e.g., convolutional neural networks, etc.), recurrent neural networks (e.g., long short-term memory recurrent neural networks, etc.), or other forms of neural networks. The machine-learned models of the cloud diagnostics server 52 may be used to analyze the appliance data transmitted from the refrigerator appliance 100. Additionally or alternatively, cloud diagnostics server 52 can train the machine-learned models through use of a model trainer (e.g., training algorithm), as would be understood. Optionally, such a model trainer may train machine-learned models based on a set of training data compiled from a plurality of different appliance models.

Cloud diagnostic server 52 may include a network interface to facilitate communication over one or more networks (e.g., network 174) with one or more network nodes. Network interface can be an onboard component or it can be a separate, off board component. In turn, cloud diagnostics server 52 can exchange data with one or more nodes over the network 174. Furthermore, although not pictured, it is understood that cloud diagnostic server 52 may further exchange data with any number of client devices over a network such as network 174. The client devices can be any suitable type of computing device, such as a general purpose computer, special purpose computer, laptop, desktop, integrated circuit, mobile device, smartphone, tablet, or another suitable computing device. Information, signals, or other data (e.g., relating to appliance performance, fault conditions, analyzation results, inputs/outputs of machine-learned models, etc.) may thus be exchanged between refrigerator appliance 100 and various separate client devices (e.g., directly to the user or maintenance technicians) through cloud diagnostic server 52.

According to exemplary embodiments, step 230 may further include determining and/or providing a confidence score along with the potential fault conditions. Specifically, as shown schematically by reference numeral 62 in FIG. 1, the output of the machine learning model and cloud diagnostics server 52 may be potential fault condition and confidence score. In this regard, the confidence score may generally refer to a probability or likelihood of the potential fault conditions actually occurring. In this regard, for example, appliance data of refrigerator appliance 100 may be analyzed to indicate that a compressor failure might occur in the near future. Moreover, this appliance data may indicate that the likelihood or confidence score associated with that potential fault condition reaches a certain level, such as low, medium, high, or very high. Alternatively, the confidence score may be expressed as a percentage, such as a 50%, 60%, 70%, 80%, 90%, or 95% chance that the potential fault condition actually occurs. This confidence score may be an output of the machine learning model or may be determined in any other suitable manner.

According to exemplary embodiments of the present subject matter, step 240 may include receiving historical fault data from a historical guidance service, such as historical guidance service 58, or other data such as service data, info, or history. Step 250 may include adjusting the confidence score (e.g., as determined at step 230) based on the received historical fault data. In this regard, the machine learning model implemented at step 230 may generate potential fault conditions and confidence scores based on the presently existing appliance data from refrigerator appliance 100 (e.g., as identified by reference numeral 62). However, historical guidance service 58 may serve to improve the accuracy or effectiveness of such identification of potential fault condition and their confidence scores, e.g., by looking at and assessing historical data (e.g., identified generally by reference numeral 64) from refrigerator appliance 100, other refrigerator appliances in operative communication with cloud diagnostic system 50, other refrigerator appliances that have received maintenance/repair service and have communicated with cloud diagnostic system 50, or any other appliance or device that includes components associated with refrigerator appliance 100 or which otherwise may affect the performance of refrigerator appliance 100.

Thus, continuing the example from above, the machine learning model from step 230 may indicate that a compressor of refrigerator appliance 100 is likely to fail with a confidence level of 80%. This confidence score of 80% may be based strictly on the appliance data received by the cloud diagnostic server 52 and the training received by the machine learning model. However, historical guidance service 58 may collect, sort, and analyze historical fault data associated with any appliance that is related to refrigerator appliance 100 in any manner, such as similar components, operating procedures, manufacturing date or location, etc. Based on this historical data, historical guidance service 58 may adjust the confidence score, e.g., by increasing the confidence score if the potential failure mode is common among similar appliances or decreasing the confidence score if the potential failure mode is uncommon among similar appliances. In other words, the confidence scores may be adjusted in a manner correlated to the probability of a particular failure mode occurring, e.g., as based on historical data, empirical data, etc. This adjusted potential fault condition and confidence score is illustrated schematically in FIG. 1 by reference numeral 66. It should be appreciated that this adjustment to the confidence score may be performed in whole or in part by cloud diagnostics server 52.

Step 260 may include communicating the potential fault conditions along with the adjusted confidence score to the appliance, to a user of the appliance, or to a field technician working on the appliance. In addition, or alternatively, method 200 may include flagging a component of the appliance for repair, service, or replacement when the machine learning model detects an anomaly in the appliance data. In this regard, if compressor failure is imminent, method 200 may include prompting the user to schedule a service visit or order a replacement part. It should be appreciated that other responsive actions may be implemented in response to the identification or prediction of potential fault conditions and their associated confidence scores.

FIG. 2 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of these methods are explained using cloud diagnostics system 50 and refrigerator appliance 100 as an example, it should be appreciated that these methods may be applied to the operation of any suitable appliance and/or diagnostic system.

As explained above, aspects of the present subject matter generally provide a system and method for using fault code hazard plot guidance in cloud diagnostics. In specific, the method and system regularly monitor, process patterns and trends from appliance fault code live data feeds reported by field technicians or communicated directly from network-connected devices. The fault data and cluster of patterns may be used to automatically acquire appliance fault code live data feeds, extract fault patterns by product lines, manufacturing site, manufacturing date, or other parameters or identifiers to calculate ratings per mean and standard deviation and update the repackaged data to a cloud service, namely fault code hazard plot guidance database. The method may further include comparing the features with a rolling time window moving average and determine the severity of the quality impact. According to exemplary embodiments, the impact severity can measure three ratings, Normal, Medium, and High. The system may update repackaged data to a cloud service, namely hazard plot guidance database.

A separate cloud-based diagnostics system can invoke the hazard plot guidance database when triggered by faulty alerts. For example, an exemplary cloud-based diagnostics system may harness a series of machine learning models that are built upon historical data sets. Therefore, the diagnostic capabilities are accurate and insensitive to the variation in the quality impacting factors. Utilizing the pattern features by matching the appliance's manufacturing site and month/year information, the cloud-based system can adjust diagnostics failure detection model thresholds by the impact severity measures accordingly. Therefore, heavily impacted products might see relatively lowered threshold while non-impacted products might maintain in an unchanged threshold. Hence, the process enhances the ability and accuracy in identifying certain clustered failure batches in production.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of diagnosing or predicting potential fault conditions in an appliance, the method comprising:
connecting the appliance to a cloud diagnostics server over a network such that data from the appliance is transmittable to the cloud diagnostics server, wherein connecting the appliance to the cloud diagnostics server comprises connecting a service computer to the appliance;
receiving, at the cloud diagnostics server, appliance data from the appliance transmitted by the service computer;
analyzing the appliance data using a machine learning model on the cloud diagnostics server to diagnose or predict the potential fault conditions; and
communicate the potential fault conditions to the appliance, to a user of the appliance, or to a field technician.

2. (canceled)

3. The method of claim 1, wherein the appliance is a connected appliance that is connected to the cloud diagnostics server through the network, and wherein the appliance data is uploaded to the cloud diagnostics server directly from the connected appliance.

4. The method of claim 1, wherein the appliance data comprises:
at least one of appliance identification data, manufacturing information, and operational data related to the potential fault conditions.

5. The method of claim 4, wherein the manufacturing information comprises at least one of a model number, a product line, a manufacturing date, a manufacturing location, or a batch number.

6. The method of claim 4, wherein the manufacturing information comprises at least one a list of appliance components or a supplier identification for one or more appliance components.

7. The method of claim 1, wherein analyzing the appliance data using the machine learning model to diagnose or predict the potential fault conditions comprises:
determining a confidence score indicative of the likelihood of the potential fault conditions.

8. The method of claim 7, further comprising:
receiving historical fault data from a historical guidance service; and
adjusting the confidence score based on the received historical fault data.

9. The method of claim 8, wherein the cloud diagnostics server and the historical guidance service are located on a single remote server.

10. The method of claim 1, wherein the machine learning model comprises at least one of a convolution neural network (“CNN”) model, a logistics model, a gradiant boost model, an XGBoost model, or a neural network.

11. The method of claim 1, further comprising:
flagging a component of the appliance for repair, service, or replacement when the machine learning model detects an anomaly in the appliance data.

12. The method of claim 1, wherein the appliance is an oven appliance, a refrigerator appliance, a dryer appliance, a microwave appliance, or a heat pump water heater appliance.

13. A cloud diagnostics system for diagnosing or predicting potential fault conditions in an appliance, the cloud diagnostics system comprising:
a cloud diagnostics server in operative communication with the appliance over a network for receiving appliance data from the appliance, the cloud diagnostics server being configured to analyze the appliance data using a machine learning model to diagnose or predict the potential fault conditions along with a confidence score;
a historical guidance service that collects historical fault data from a plurality of appliances, sorts the historical fault data, and analyzes the historical fault data, wherein the confidence score is adjusted based at least in part on the historical fault data; and
a service computer that is connected to the appliance such that the appliance data from the appliance is transmittable to the service computer.

14. (canceled)

15. The system of claim 13, wherein the appliance is a connected appliance that is connected to the cloud diagnostics server through the network, and wherein the appliance data is uploaded to the cloud diagnostics server directly from the connected appliance.

16. The system of claim 13, wherein the appliance data comprises:
at least one of appliance identification data, manufacturing information, and operational data related to the potential fault conditions.

17. The system of claim 16, wherein the manufacturing information comprises at least one of a model number, a product line, a manufacturing date, a manufacturing location, or a batch number.

18. The system of claim 13, wherein the cloud diagnostics server is configured to:
determine a confidence score indicative of the likelihood of the potential fault conditions.

19. The system of claim 13, wherein the cloud diagnostics server and the historical guidance service are located on a single remote server.

20. The system of claim 13, wherein the machine learning model comprises at least one of a convolution neural network (“CNN”) model, a logistics model, a gradiant boost model, an XGBoost model, or a neural network.
